(19) United States
(12) Patent Application Publication
(10) Pub. No.: US 2019/0018751 A1
(43) Pub. Date: Jan. 17, 2019

(54) Digital Asset Tracking System And Method

(71) Applicant: Custodio Technologies Pte Ltd, Singpore (SG)

(72) Inventor: Amir DAVIDI, Singapore (SG)

(21) Appl. No.: 16/032,066

(22) Filed: Jul. 10, 2018

(30) Foreign Application Priority Data
Jul. 11, 2017 (SG) 10201705700R

(51) Int. Cl. G06F 11/34; G06F 17/30; H04L 29/06; G06F 9/54

(52) U.S. Cl. CPC G06F 11/3476; G06F 17/30144; G06F 2201/86; G06F 9/541; H04L 63/1416

(57) ABSTRACT

A digital asset tracking system comprises one or more Client Machine (CM) being installed with an Agent; wherein the Agent determines digital asset to be armed and selects arming method to arm the to-be-armed digital asset; an Asset Management Platform (AMP) managed by a System Administrator; wherein the AMP allows the System Administrator to make informed decisions on which assets are to be armed for monitoring; and a Callback Server being installed in a server, hosted either by cloud service provider or in an enterprise network on an internet facing interface; wherein the Callback Server listens-in and logs all communications received from armed assets; and when an armed asset is being opened and viewed, the arming on the armed asset triggers a communication back to the Callback Server that logs all communications received. A digital asset tracking method is also provided.

### FIELD OF THE INVENTION

The present invention relates to the digital technology, and more specifically to a digital asset tracking system, and furthermore to a method for digital asset tracking.

### BACKGROUND OF THE INVENTION

In any organization, management consistently faces the possibility of that digital assets (documents, multimedia files) are illegally accessed by an unauthorized party or exfiltrated out from the organization's network to an “unauthorized” machine. These assets may contain confidential and secret information. Once the asset is in the hands of an unauthorized party, the organization is left with little means to track its whereabouts, especially when the machine is not controlled by the organization.

Digital asset protection has been a challenge in the industry. Current solutions for digital asset protection are primarily network- or endpoint-based. For example, Data Leakage Prevention (DLP) focuses on recognizing the protected assets at rest, in-use, or in-transit. DLP primarily focuses on preventing unauthorized users from illegally accessing digital assets and detecting data loss to unauthorized users. DLP works via equipment controlled and/or managed by an enterprise (e.g. client machine issued to employees, servers and network appliances in the company network). In addition, Digital Right Management (DRM) provides a different level of protection; it works to protect sensitive and/or protected data by checking if a user accessing the data has proper rights to it. It is endpoint-based, focusing on controlling the use, modification, and distribution of sensitive data and content (e.g. copyrighted works such as software) by unauthorized user(s) on machines which might/might not be managed by the organization. It works by limiting the access to sensitive document via an endpoint agent or services which enforce access control at a lower granularity (e.g. read, write, copy and paste, printing etc). DRM relies on a DRM agent/service to be started. It is not covert and can potentially be circumvented if the unauthorized user(s) founds a way to open the document without starting the DRM agent/service and by hiding the unauthorized access from the backend DRM server. Both DLP and DRM have little or no attribution capability to allow the organization to know where an asset has been leaked to.

There are currently no definitive solutions that identifies the presence of such assets that have been illegally accessed and circulated in the wild. Therefore, there is imperative need to have a digital asset protection solution that can detect leakage of assets after it has been leaked already.

### SUMMARY OF THE INVENTION

One aspect of the present invention provides a digital asset tracking system. In one embodiment, the digital asset tracking system comprises one or more Client Machine (CM) being installed with an Agent; wherein the Agent determines digital asset to be armed and selects arming method to arm the to-be-armed digital asset; an Asset Management Platform (AMP) managed by a System Administrator; wherein the AMP allows the System Administrator to make informed decisions on which assets are to be armed for monitoring; and a Callback Server being installed in a server, hosted either by cloud service provider or in an enterprise network on an internet facing interface; wherein the Callback Server listens-in and logs all communications received from armed assets; and when an armed asset is being opened and viewed, the arming on the armed asset triggers a communication back to the Callback Server that logs all communications received.

In another embodiment of the digital asset tracking system, the CM is selected from the group consisting of a desktop, a laptop, and a mobile device.

In another embodiment of the digital asset tracking system, the AMP comprises an API Server, a Database Server, and an Asset Administrator Web Application; wherein the API Server is an interface that provides means for other components to send and receive information from the Database Server; wherein the Database Server stores operational and information data that is used by the digital asset tracking system; and wherein the Asset Administrator Web Application is a web application server that hosts a web portal for the System Administrator to interact with and manage the digital asset tracking system; thereby when the Asset Administration Web Application prompts the System Administrator to view the assets identified in each CM, to indicate which of the assets are armed and which are not, and to select the asset(s) that needs to be armed for monitoring, the database in the Database Server is updated when an “arm” action(s) is saved.

In another embodiment of the digital asset tracking system, the web portal is accessed via an administrator web browser.

In another embodiment of the digital asset tracking system, the API Server routinely retrieves those logs and perform analysis; thereby the information gleaned from the analysis is presented in the Asset Administration Web Application so that the System Administer uses the information to identify which armed assets are accessed, where they are accessed from, and information of the user identity and the underlying IT environment where the armed asset was accessed.

In another embodiment of the digital asset tracking system, the Agent comprises a Fingerprinting Module extracting basic system information of the CM as inputs, using the extracted basic system information to create its System Profile as outputs; an Asset Collection Module extracting from the CM Digital Assets such as documents, multimedia files, and folders as inputs, and then using the extracted documents, multimedia files, and folders to create an Asset List; thereby the Asset List is a list of the names and information of the digital assets residing in a CM; a Policy Module determining digital assets to be armed and selecting arming methods to arm the to-be-armed digital assets; and a Communication Module transmitting the System Profile and the Asset List to the AMP.

In another embodiment of the digital asset tracking system, the basic system information of the CM includes hostname, OS version, IP address, MAC address, and hard disk serial number, and installed applications.

In another embodiment of the digital asset tracking system, the Asset Collection Module routinely checks for updates on the information of the Asset List.

Another aspect of the present invention provides a digital asset tracking method. In one embodiment, the digital asset tracking method comprises identifying and registering digital assets; wherein the identifying and registering digital assets includes extracting and fingerprinting basic system information of a CM to create a System Profile, extracting names and information of digital assets residing in the CM to create an Asset List; and transmitting the System Profile and Asset List to an Asset Management Platform to be stored therein; and wherein the Asset List is routinely updated; determining digital assets to be armed based on type of asset, applications available and application version; arming the digital assets by inserting a process or enabling a service within the digital asset, such that when the digital asset is opened by its associated application, the process or service is parsed and triggers a “callback”; wherein the arming digital assets includes arming digital assets that are identified to be armed for monitoring by a System Administrator; wherein the database is updated when an “arm” action(s) is saved; calling-back by calling back to a Callback Server when the process or service within the digital asset is triggered; where the calling-back includes logging in all communications received about opening and reviewing an armed asset; and routinely retrieving those logs and performing analysis of the retrieved logs.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 shows a schematic diagram of environment for tracking digital assets using the digital asset tracking system in accordance with one embodiment of the present invention.

FIG. 2 shows a functional block diagram of Agent in accordance with one embodiment of the present invention.

FIG. 3 shows a functional block diagram illustrating the operation of the Fingerprinting Module in accordance with one embodiment of the present invention.

FIG. 4 shows a functional block diagram illustrating the operation of the Asset Collection Module in accordance with one embodiment of the present invention.

FIG. 5 shows a functional block diagram illustrating the operation of the Policy Module in accordance with one embodiment of the present invention.

FIG. 6 shows a flowchart illustrating the method of tracking digital assets in accordance with one embodiment of the present

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides a digital asset tracking system for data leak detection with attribution capabilities. The digital asset tracking system uses unobtrusive methods of arming digital assets, primarily assets-of-interest which the organization needs to keep a tab on their whereabouts. The digital asset tracking system equips an organization with the capabilities of being notified, being situational awareness of, and being presented with intelligence when an asset is accessed.

For the purpose of this application, “asset” or “digital asset” refers to digital or computer files that contains a sequence of bytes readable by a computer. These digital or computer files are usually adapted to be read by compatible computer programs/applications to reveal the information stored therein. The information may contain text characters, image pixels, or audio samples, etc. or combinations of those.

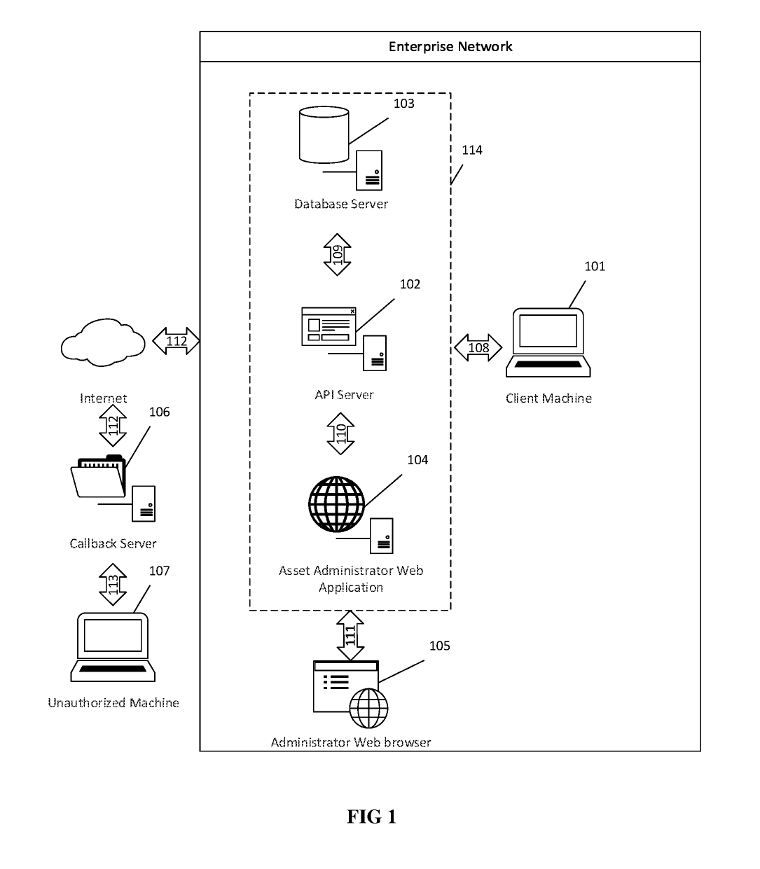

Referring now to FIG. 1, there is provided a schematic diagram of environment for tracking digital assets using the digital asset tracking system in accordance with one embodiment of the present invention.

The digital asset tracking system 1 comprises: one or more Client Machine (CM) 101 being installed with an Agent; an Asset Management Platform (AMP) 114 managed by a System Administrator; and a Callback Server 106. The Callback Server 106 is installed in a server, hosted either by cloud service provider or in the enterprise network on an internet facing interface.

The CM 101 can be a desktop, a laptop, or a mobile device. The CM 101 is a property of an organization and connected to the organization's IT network. And the CM 101 is installed with an Agent as described hereinbelow.

The AMP 114 comprises an API Server 102, a Database Server 103, and an Asset Administrator Web Application 104. The API Server 102 is the interface that provides the means for other components to send and receive information from the Database Server 103. The Database Server 103 stores operational and information data that is used by the digital asset tracking system 1. The Asset Administrator Web Application 104 is a web application server that hosts a web portal for the System Administrator to interact with the digital asset tracking system 1. This portal is accessed via an administrator web browser 105. A System Administrator manages the digital asset tracking system 1 through the Asset Administration Web Application 104. The administrator web browser 105 can be a standard internet browser. The information presented on the Asset Administration Web Application 104 will allow the System Administrator to make informed decisions on which assets are to be armed for monitoring. The Asset Administration Web Application 104 prompts the System Administrator to view the assets identified in each CM 101, to indicate which of the assets are armed and which are not, and to select the asset(s) that needs to be armed for monitoring. The database in the Database Server 103 is updated when an “arm” action(s) is saved.

The Callback Server 106 will be an internet facing server that listens-in and logs all communications received from armed assets. When an armed asset is being opened and viewed, the arming on the armed asset triggers a communication back to the Callback Server 106 that logs all communications received. The API Server 102 will routinely retrieve those logs and perform analysis. Information gleaned from the analysis process is presented in the Asset Administration Web Application 104. The information is used by the System Administrator to identify which armed assets are accessed, where they are accessed from, and information of the user identity and the underlying IT environment where the armed asset was accessed.

In the present invention, an Unauthorized Machine 107 refers to a machine, not authorized to have in possession of the digital asset, which accesses the armed assets, triggering a communication back to the Callback Server 106.

For the present invention, System Administrator denotes a user with administrative authority and decision making responsibility within the organization; Employee denotes a user who is an employee of the organization and the owner of the CM 101; Unauthorized User denotes a person with no permission given to access the organization's digital asset; Arming denotes the act of arming an asset with certain techniques possible on that asset; and Callback denotes the activity where an armed asset communicates back to the Callback server 106.

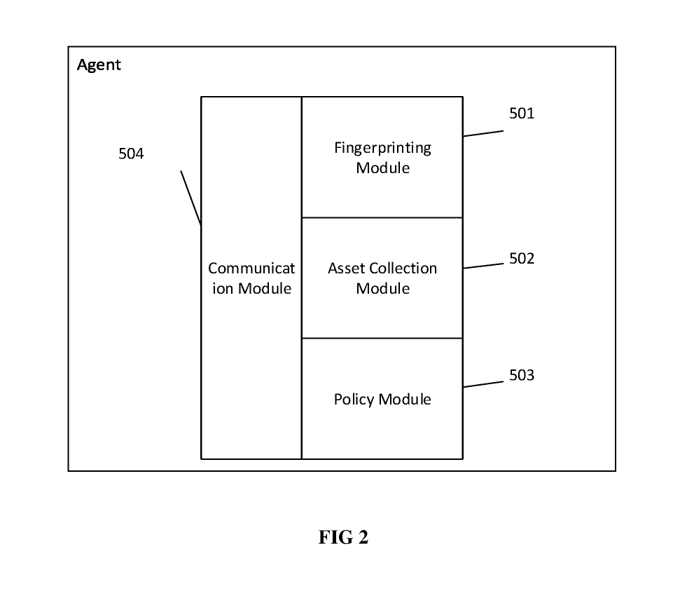

Referring now to FIG. 2, there is provided a functional block diagram of the Agent in accordance with one embodiment of the present invention. The Agent comprises a Fingerprinting Module 501, an Asset Collection Module 502, a Policy Module 503, and a Communication Module 504.

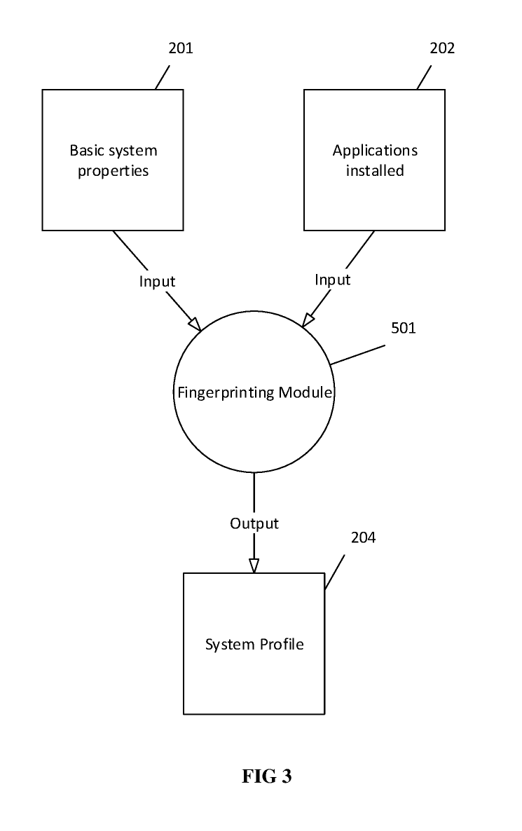

Referring now to FIG. 3, there is provided a functional block diagram illustrating the operation of the Fingerprinting Module 501 in accordance with one embodiment of the present invention. The Fingerprinting Module 501 extracts basic system information of the CM 101 as inputs, where the basic system information of the CM 101 may include basic system properties 201 like hostname, OS version, IP address, MAC address, and hard disk serial number, and installed applications 202; then Fingerprinting Module 501 uses the extracted basic system information to create its System Profile 204 as output.

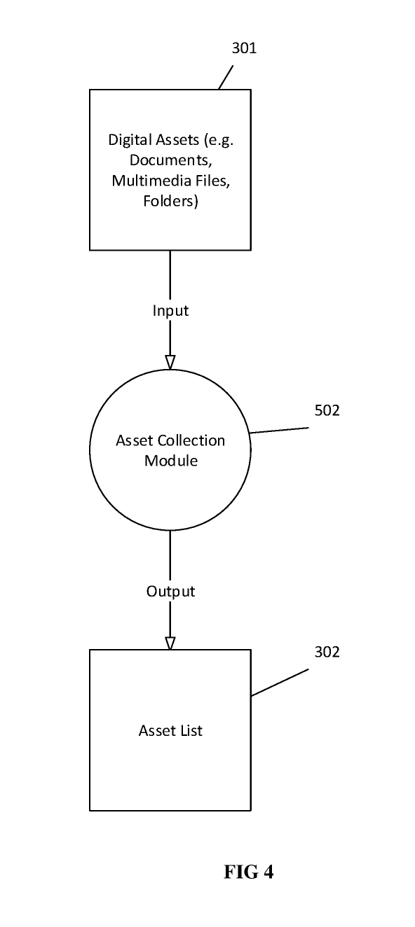

Referring now to FIG. 4, there is provided a functional block diagram illustrating the operation of the Asset Collection Module 502 in accordance with one embodiment of the present invention. The Asset Collection Module 502 extracts from the CM 101 the Digital Assets 301 such as documents, multimedia files (images, videos, audios etc), and folders as inputs, and then uses the extracted documents, multimedia files, and folders to create an Asset List 302, where the Asset List 302 is a list of the names and information of the digital assets residing in a CM 101. The Asset Collection Module 502 also routinely checks for updates on the information of the Asset List 302.

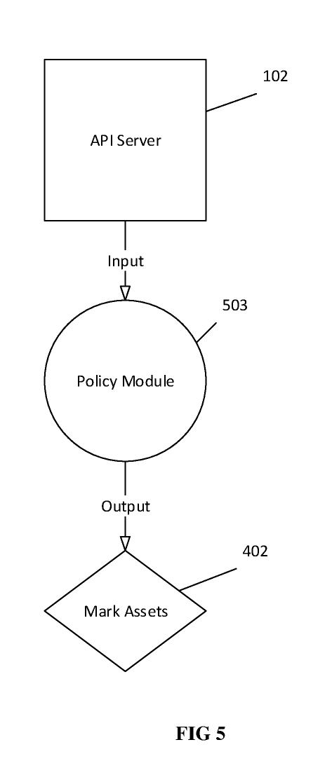

Referring now to FIG. 5, there is provided a functional block diagram illustrating the operation of the Policy Module 503 in accordance with one embodiment of the present invention. The Policy Module 503 will query the Database Server 103 via the API Server 102 about which assets are to be armed. The responsibility of determining which digital asset to be armed belongs to the System Administrator. The System Administrator will, based on any IT security policy defined in his organization, make the decision of which digital asset(s) to be armed. The System Administrator will act on that decision by performing the necessary arming selection as discussed hereinbelow. Additionally, the System Administrator can formulate that decision as a policy with rule(s) via the Asset Administration Web Application 104. Each rule specifies under which circumstances or attributes present in a digital asset so that the digital asset should be armed. The policy can also include the arming method to be applied on the digital asset. Multiple policies can be defined. Digital assets recorded in the Database Server 103 are checked against the policies to determine if it satisfies any of the rules defined in each policy. Subsequently, matched digital assets will be earmarked for being armed in the Database Server 103. The assets identified to be armed are armed by Mark Assets 402. The assets are armed using the appropriate method(s) in a manner such that it is leaves minimal digital footprints that will not alert or interrupt the Employee using the CM 101.

How to select the digital asset needed to be armed is done on the Asset Administrator Web Application 104. The list of available digital assets to be armed is presented to the System Administrator and the System Administrator selects the digital asset on the Asset Administrator Web Application 104 and submits the selection. The API Server 102 receives that instruction and updates the Database Server 103. The task of performing the arming is done by the Agent. When the Agent receives the instruction on which asset to be armed on the CM 101, the Agent checks the following:

a. Type of asset: Determine the file type;

b. Applications available: Determine the associated applications available on the CM 101 that this asset can opened with. For example, if it is a word document, it can be opened with Microsoft Office Word and Open Office;

c. Application version: Determine the version number of the identified applications.

After the Agent has performed the above checks, it will select appropriate arming method(s) to be employed on this asset. The decision on which method is to be used to arm an asset is based on a number of conditions that are to be matched, where the conditions include type of asset, applications available, and application version. This will ensure that the arming result is a success as much as possible.

Arming Methods

The methods used to arm the assets takes advantage of the features present in underlying applications that is used to open and modify such assets. The features that are selected are based on their ability to achieve the necessary callback requirement for this system to work.

Persistent Arming and Notification

The Agent will continuously monitor the armed assets to perform persistent arming. It will look out for the following events:

a. Copying of contents (partial or full) of asset;

b. Copying of asset to another destination;

c. Duplicate of asset;

d. Printing of asset.

When the Agent detects the above events, it has to:

a. Arm the new asset where the contents were copied to;

b. Arm the duplicated asset;

c. Send an alert to the system to notify the System Administrator of activities related to the above events.

Arming the digital asset involves the process of inserting a process or enabling a service within the digital asset, such that when the digital asset is opened by its associated application, the process or service is parsed and triggers a “callback” to the Callback Server 106.

Referring back to FIG. 2, the Communication Module 504 transmits the System Profile 204 and the Asset List 302 to the AMP 114 by the API Server 102 through available functions. The Database Server 103 of the AMP 114 stores the received System Profile 204 and Asset List 302.

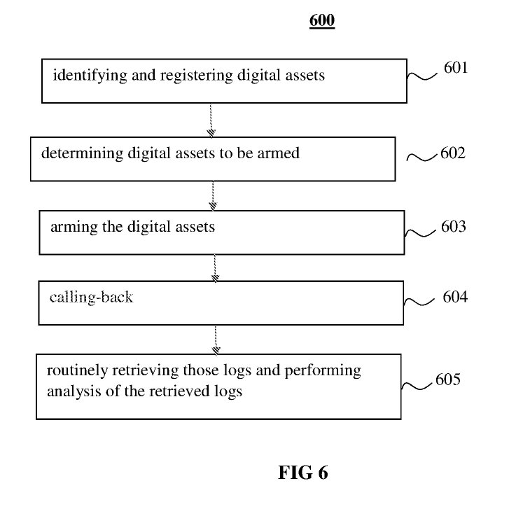

Referring now to FIG. 6, there is provided a flowchart illustrating the method of tracking digital assets in accordance with one embodiment of the present invention.

The method of tracking digital assets 600 comprises the following steps:

identifying and registering digital assets 601; where the identifying and registering digital assets 601 includes extracting and fingerprinting the basic system information of a CM 101 to create a System Profile 204, extracting names and information of digital assets residing in the CM 101 to create an Asset List 302; and transmitting the System Profile 204 and Asset List 302 to an Asset Management Platform 114 to be stored therein; and where the Asset Lit 302 is routinely updated;

determining digital assets to be armed 602 as described above;

arming the digital assets 603; where the arming digital assets 603 includes arming digital assets that are identified to be armed for monitoring by a System Administrator; where the database is updated when an “arm” action(s) is saved;

calling-back 604; where the calling-hack 604 includes logging in all communications received about opening and reviewing an armed asset, where the communications are triggered by the opening of the armed asset;

routinely retrieving those logs and performing analysis of the retrieved logs 605 by the API Server 102; where information gleaned from the analysis process is presented in the Asset Administration Web Application 104; where the information is used by the System Administrator to identify which armed assets are accessed, where are the accessed from, and information of the user identity and the underlying IT environment where the armed asset was accessed.

The present invention has advantages including covert operation, passive means to callback and gather information, and determination of “Circle of Friends”.

Covert Operation

The process of registering the CM 101, asset identification and collection, and arming of assets performed by the Agent are done with a high level of covertness:

a. The above processes will not change and interrupt how the employee interacts with the CM 101, the applications, and the assets on the CM 101;

b. The above processes will not leave obvious “tell-tale” signs when completed. The employee will not see “footprints” that will indicate that there is a change in the asset not performed by the employee.

Passive means to callback and gather information

The system uses passive means for callback and gather information about the authorized user and his/her machine (i.e. attribution data):

a. Does not rely on the execution of new binaries or code on the machine of the unauthorized user. (From the technical perspective, it does not need a “new process or services” to be started on the machine of the unauthorized user and no addition privileges are required.

b. Does not need machine of unauthorized user to be preconfigured or managed by the organization.

Determination of “Circle of Friends”

The system will analyze the callbacks received and form a timeline of the “history” of the asset:

a. When the asset was armed;

b. When and where the asset was accessed;

c. The identity of the people who accessed the asset;

d. “Circle-of-Friends”: Group of people associated with each asset.

The information provided from the above analysis will give valuable intelligence for the System Administrator to work on.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

What is claimed is:

1. A digital asset tracking system, comprising:
one or more Client Machine (CM) being installed with an Agent; wherein the Agent determines digital asset to be armed and selects arming method to arm the to-be-armed digital asset;
an Asset Management Platform (AMP) managed by a System Administrator; wherein the AMP allows the System Administrator to make informed decisions on which assets are to be armed for monitoring; and
a Callback Server being installed in a server, hosted either by cloud service provider or in an enterprise network on an internet facing interface; wherein the Callback Server listens-in and logs all communications received from armed assets; and when an armed asset is being opened and viewed, the arming on the armed asset triggers a communication back to the Callback Server that logs all communications received.

2. The digital asset tracking system of claim 1, wherein the CM is selected from the group consisting of a desktop, a laptop, and a mobile device.

3. The digital asset tracking system of claim 1, wherein the AMP comprises an API Server, a Database Server, and an Asset Administrator Web Application;
wherein the API Server is an interface that provides means for other components to send and receive information from the Database Server;
wherein the Database Server stores operational and information data that is used by the digital asset tracking system; and
wherein the Asset Administrator Web Application is a web application server that hosts a web portal for the System Administrator to interact with and manage the digital asset tracking system;
thereby when the Asset Administration Web Application prompts the System Administrator to view the assets identified in each CM, to indicate which of the assets are armed and which are not, and to select the asset(s) that needs to be armed for monitoring, the database in the Database Server is updated when an “arm” action(s) is saved.

4. The digital asset tracking system of claim 3, wherein the web portal is accessed via an administrator web browser.

5. The digital asset tracking system of claim 3, wherein the API Server routinely retrieves those logs and perform analysis; thereby the information gleaned from the analysis is presented in the Asset Administration Web Application so that the System Administer uses the information to identify which armed assets are accessed, where they are accessed from, and information of the user identity and the underlying IT environment where the armed asset was accessed.

6. The digital asset tracking system of claim 1, wherein the Agent comprises:
a Fingerprinting Module extracting basic system information of the CM as inputs, using the extracted basic system information to create its System Profile as outputs;
an Asset Collection Module extracting from the CM Digital Assets such as documents, multimedia files, and folders as inputs, and then using the extracted documents, multimedia files, and folders to create an Asset List; thereby the Asset List is a list of the names and information of the digital assets residing in a CM;
a Policy Module determining digital assets to be armed and selecting arming methods to arm the to-be-armed digital assets; and
a Communication Module transmitting the System Profile and the Asset List to the AMP. To receive arming policy and transmit arming result to AMP.

7. The digital asset tracking system of claim 6, wherein the basic system information of the CM includes hostname, OS version, IP address, MAC address, and hard disk serial number, and installed applications.

8. The digital asset tracking system of claim 6, wherein the Asset Collection Module routinely checks for updates on the information of the Asset List.

9. A digital asset tracking method, comprising:
identifying and registering digital assets; wherein the identifying and registering digital assets includes extracting and fingerprinting basic system information of a CM to create a System Profile, extracting names and information of digital assets residing in the CM to create an Asset List; and transmitting the System Profile and Asset List to an Asset Management Platform to be stored therein; and wherein the Asset List is routinely updated;
determining digital assets to be armed based on type of asset, applications available and application version;
arming the digital assets by inserting a process or enabling a service within the digital asset, such that when the digital asset is opened by its associated application, the process or service is parsed and triggers a “callback”; wherein the arming digital assets includes arming digital assets that are identified to be armed for monitoring by a System Administrator; wherein the database is updated when an “arm” action(s) is saved;
calling-back by calling back to a Callback Server when the process or service within the digital asset is triggered; where the calling-back includes logging in all communications received about opening and reviewing an armed asset; and
routinely retrieving those logs and performing analysis of the retrieved logs.
